(19) United States
(12) Patent Application Publication
(10) Pub. No.: US 2023/0056067 A1
(43) Pub. Date: Feb. 23, 2023

(54) PULLING APPARATUS AND SYSTEMS AND METHODS THEREOF

(71) Applicant: Wendell W. Williams, Brownwood, TX (US)

(72) Inventor: Wendell W. Williams, Brownwood, TX (US)

(21) Appl. No.: 17/445,322

(22) Filed: Aug. 18, 2021

(51) Int. Cl. A01G 23/06

(52) U.S. Cl. CPC A01G 23/065

(57) ABSTRACT

A pulling apparatus for separating one or more objects from a surface is presented. The apparatus can include a frame, one or more support members, a gripping member, and an impactor member. The apparatus can be coupled with a vehicle, such as a loader bucket of a vehicle, and can further be configured to utilize a power source of the vehicle, such as hydraulics, electricity, or any other power source. In another embodiment, the present disclosure can include a tree pulling system including a vehicle and a pulling apparatus. In another embodiment, the present disclosure can include a method of pulling a tree from the ground that can maximize efficiency by positioning an object along a common axis with one or more support members, such that force vectors representing a driving force generated by the one or more support members can be aligned with the object being pulled.

### CROSS-REFERENCE TO RELATED APPLICATIONS

None.

### STATEMENT OF FEDERALLY SPRONSORED RESEARCH OR DEVELOPMENT

None.

### REFERENCE TO A SEQUENCE LISTING, A TABLE, OR A COMPUTER LISTING COMPACT DISC APPENDIX

None.

### TECHNICAL FIELD

The present disclosure relates generally to apparatuses, systems, and methods for pulling objects from surfaces and/or raising objects from surfaces, specifically, in one embodiment, pulling trees from the ground.

### BACKGROUND

Invasion of inferior and parasitic tree varieties have plagued farmers and ranchers for the past one hundred years. Mesquites, junipers, cedars, and others of these varieties shade out useful forage vegetation and deplete precious rainfall and groundwater resources. While the United States Department of Agriculture has recognized this problem and maintains some programs to assist in funding solutions to this problem, it nevertheless remains the burden of the landowner to bear significant costs of parasitic tree removal. This problem is exacerbated by the fortitude of these parasitic varieties—the tree must generally be ripped up, roots and all, to prevent these trees from regrowing. Some of these trees, such as juniper trees, also have immensely complex and cumbersome root systems and/or root balls which accumulate dirt and other debris when a tree is removed.

One solution for tree removal is to use heavy equipment such as bulldozers. However, use of such equipment can destroy ground cover via the tracks of the equipment. Additionally, pushing a tree out with a bulldozer can leave gaping holes and/or root plows, often around twelve feet wide, which penetrate the soil by dozens of inches. After trees are removed in such a manner, it is then often necessary to rake the trees into a pile to burn, and unfortunately, the piles do not burn well as there is a large amount of dirt that clings to the removed trees. Therefore, landowners then have to scatter, re-rake, and re-burn a pile several times to dispose of the nuisance trees. Such injury caused by crude, destructive removal of the parasitic trees unnecessarily damages the landscape and can often necessitate, e.g., reseeding of pastures. It can also be necessary to then re-plow the land several times for it to be used, such as to form roads, etc. Another method of tree removal includes the use of large track-hoes and/or excavators to dig out each tree. This method can also leave behind a very large footprint and cause land disfiguration. This method also generally necessitates re-raking and re-burning of debris piles. The average farmer or rancher often times cannot afford the cost of either the equipment, its usage, or the reclamation time.

Other solutions have been presented that attempt to provide tools for tree extraction that can be used with, e.g., skid steer loaders. For example. U.S. patent application Ser. No. 15/195,659 discloses a mini-skid steer loader extractor. However, such design has numerous issues, including jaw members that are not optimized to grip trees, and the extractor relies entirely on the force of the skid steer to remove trees. For example, the '659 Application design only allows for gripping of a tree and otherwise does not assist in removal of the tree, requiring the skid steer to bear the entire burden of lifting the tree from the ground. Additionally, the jaw design fails to maximize a gripping force applied to a tree—a tree within the '659 Application jaws would be contacted by just a few teeth, meaning that the surface area of contact is minimal, potentially leading to slippage while pulling a tree from the ground.

As another example, U.S. Pat. No. 10,015,937 teaches a tree, stump, and post puller that attaches to a three-point hitch tractor accessory. Notably, the '937 Patent teaches chisel-like members with which to grip a tree, which again suffers the same drawbacks as the '659 Application with respect to minimized gripping surface area. Additionally, while the '937 Patent apparatus has a lifting frame, the apparatus suffers the drawback of applying a lifting force from a side of the object being lifted with now counterbalancing force to complement it—e.g., the lifting force can pull the apparatus forward during lifting, leading to substantial imbalance during lifting and damaging lifting efficiency. For example, as the '937 Patent apparatus lifts a stump, the apparatus is pulled towards the stump, misaligning the direction of the force applied as compared to the desired direction of removal.

### SUMMARY

It is an object of the present disclosure to provide for the efficient removal of trees from the ground. In on embodiment, the present disclosure can include a new use for equipment, and further render certain large equipment obsolete with respect to tree clearing. In one embodiment, the present disclosure can eliminate the need for raking, re-raking, plowing, and re-seeding by providing for removal of trees with minimal disturbance to landscape and/or the existing native vegetation thereon. In another embodiment, the present disclosure can enable the removal of a tree and its roots while minimizing the size of the hole formed, and further provide for moving the tree to a disposal point. In another embodiment, the present disclosure can be extremely advantageous in that the average farmer or rancher can utilize equipment they likely already own along with the apparatuses, systems, and methods described herein. In another embodiment, the present disclosure can significantly reduce the cost of land clearing and tree clearing.

In another embodiment, the present disclosure can include an optimized method of tree pulling, and/or an apparatus that optimizes tree pulling. For example, an apparatus in accordance with the principles of the present disclosure can provide at least two force vectors generated by an apparatus that can be aligned with the direction of removal of a tree. In another example, a method and/or apparatus in accordance with the principles of the present disclosure can include at least two support members, such as support members that can drive and/or hoist the apparatus and/or object gripped thereby, and each support member can be positioned along an axis along with an object being pulled. In another example, an axis can be defined by a first support member, a gripping member (and/or an object gripped by the gipping member), and a second support member. In another embodiment, such alignment can prevent imbalance during lifting by axially positioning an object being lifted between two support members, such that, e.g., the center of gravity (and/or center of force) can be aligned with the object.

In another embodiment, the present disclosure can include a pulling apparatus, the apparatus comprising: a frame including a first side and a second side; a first support member operably coupled to the first side of the frame, the first support member including a first shaft having a first end; a second support member operably coupled to the second side of the frame, the second support member including a second shaft having a first end; and a gripping member coupled to the frame between the first and second support members, wherein each of the first and second shafts are configured to extrude from the frame. Wherein the frame is configured to couple to a vehicle. Wherein each of the first and second support members are configured to drive the frame via extrusion of the first and second shafts. Wherein extrusion of the first and second shafts is hydraulically powered. Further including an impactor member disposed below the gripping member. Wherein the impactor member includes at least one tine. Wherein the gripping member is hydraulically powered. Wherein the impactor member is hydraulically powered. Further including a first foot coupled to the first end of the first shaft and a second foot coupled to the first end of the second shaft. Wherein the first ends of the first and second shafts include ball studs. Wherein each of the first foot and second foot include a cup configured to receive the ball studs. Wherein each of the first and second support members are positioned along an axis of the gripping member. Wherein the gripping member includes jaws. Wherein the frame is configured to couple to a loader bucket. Wherein the impactor member is configured to utilize compressed air.

In another embodiment, the present disclosure can include a method of raising an object from a surface, the method comprising the steps of: orienting an object relative to a gripping member coupled to a frame, wherein the gripping member is coupled between a first side and a second side of the frame; gripping the object with the gripping member; and driving the object and the frame upwards via a first extrudable support coupled proximate the first side of the frame and a second extrudable support coupled proximate the second side of the frame. Wherein the frame is coupled to a vehicle. Wherein at least one of the first extrudable support, second extrudable support, and gripping member is powered via the vehicle.

In another embodiment, the present disclosure can include a tree-pulling system, the system comprising: a vehicle including a loader bucket; a pulling apparatus including: a frame including a first side and a second side; a first support member operably coupled to the first side of the frame, the first support member including a first shaft; a second support member operably coupled to the second side of the frame, the second support member including a second shaft; and a gripping member coupled to the frame between the first and second support members, wherein the frame is coupled to the loader bucket. Wherein each of the first and second shafts are configured to extrude from the frame. Wherein the pulling apparatus is configured to couple with hydraulics of the vehicle.

### BRIEF DESCRIPTION OF THE DRAWINGS

The present disclosure will be readily understood by the following detailed description, taken in conjunction with the accompanying drawings that illustrate, by way of example, the principles of the present disclosure. The drawings illustrate the design and utility of one or more exemplary embodiments of the present disclosure, in which like elements are referred to by like reference numbers or symbols. The objects and elements in the drawings are not necessarily drawn to scale, proportion, or precise positional relationship. Instead, emphasis is focused on illustrating the principles of the present disclosure.

FIG. 1A illustrates a perspective view of a pulling apparatus in accordance with one or more exemplary embodiments of the present disclosure;

FIG. 1B illustrates a perspective view of a pulling apparatus in accordance with one or more exemplary embodiments of the present disclosure;

FIG. 1C illustrates a perspective view of a pulling apparatus in accordance with one or more exemplary embodiments of the present disclosure;

FIG. 1D illustrates a perspective view of a pulling apparatus in accordance with one or more exemplary embodiments of the present disclosure;

FIG. 1E illustrates a perspective view of a pulling apparatus in accordance with one or more exemplary embodiments of the present disclosure;

FIG. 1F illustrates a perspective view of a pulling apparatus in accordance with one or more exemplary embodiments of the present disclosure;

FIG. 1B illustrates a perspective view of a drill jig that can include first, second, and third members in accordance with one or more exemplary embodiments of the present disclosure;

FIG. 2 illustrates a perspective view of a tree pulling apparatus in accordance with one or more exemplary embodiments of the present disclosure;

FIG. 3 illustrates a tree clearing apparatus in accordance with one or more exemplary embodiments of the present disclosure;

FIG. 4A illustrates a tree-pulling system in accordance with one or more exemplary embodiments of the present disclosure; and

FIG. 4B illustrates a tree-pulling system in accordance with one or more exemplary embodiments of the present disclosure.

### DETAILED DESCRIPTION

The preferred version of the disclosure presented in the following written description and the various features and advantageous details thereof, are explained more fully with reference to the non-limiting examples included in the accompanying drawings and as detailed in the description, which follows. Descriptions of well-known components have been omitted so to not unnecessarily obscure the principle features described herein. The examples used in the following description are intended to facilitate an understanding of the ways in which the disclosure can be implemented and practiced. Accordingly, these examples should not be construed as limiting the scope of the claims.

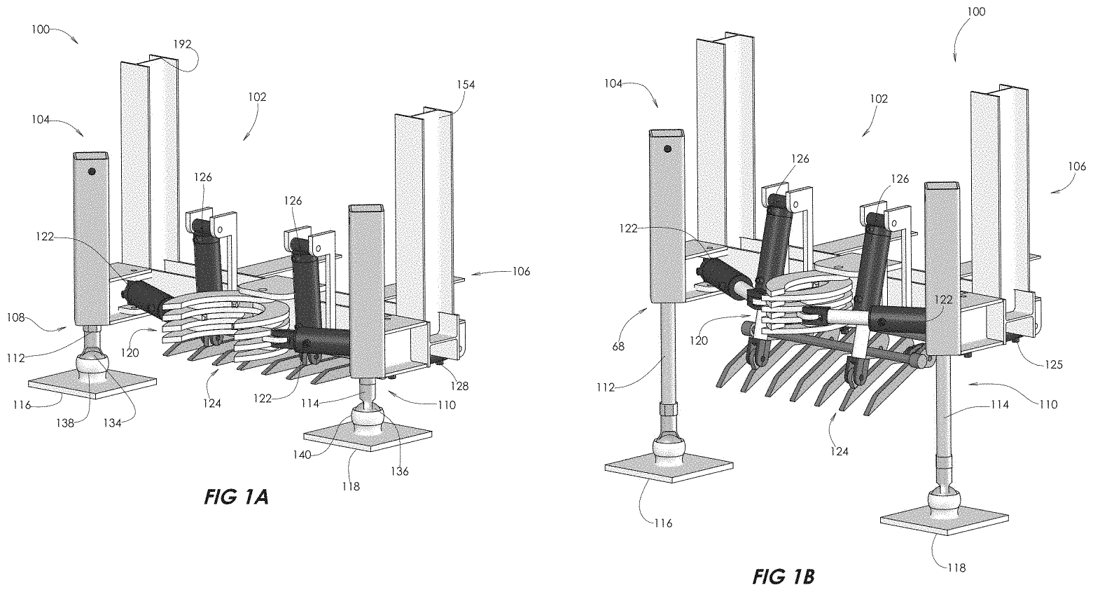

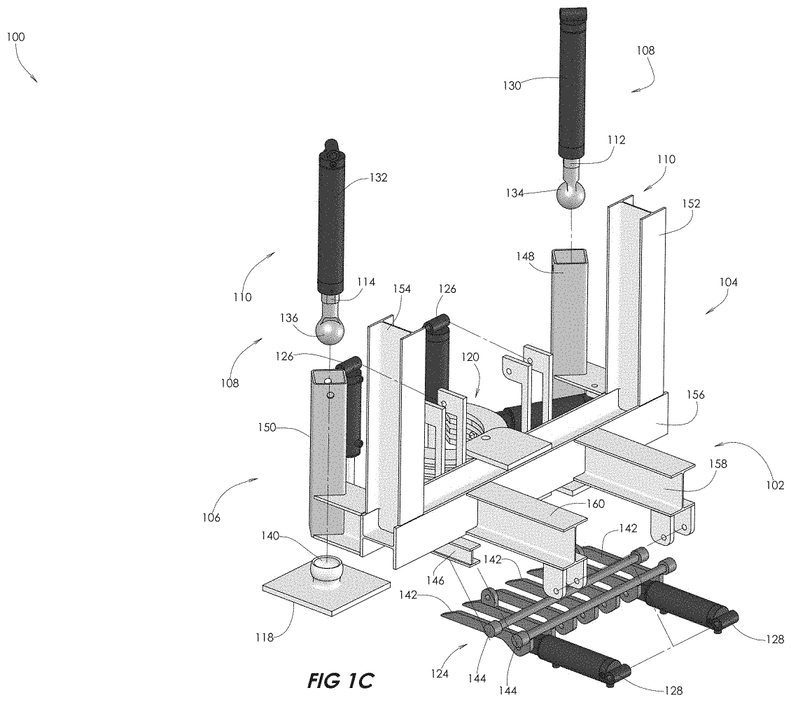

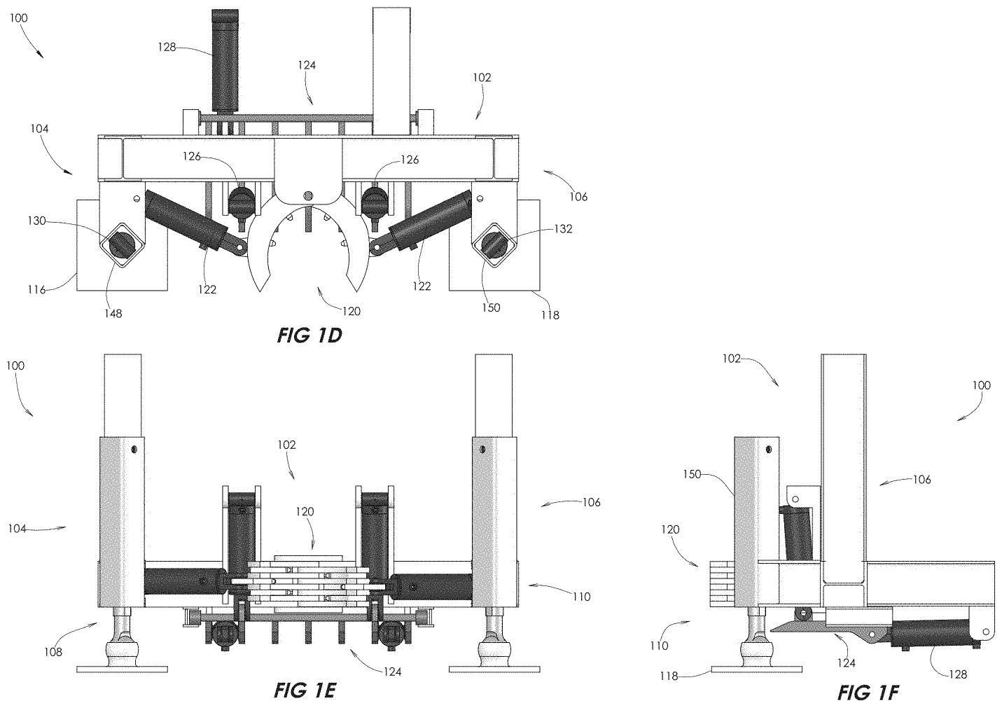

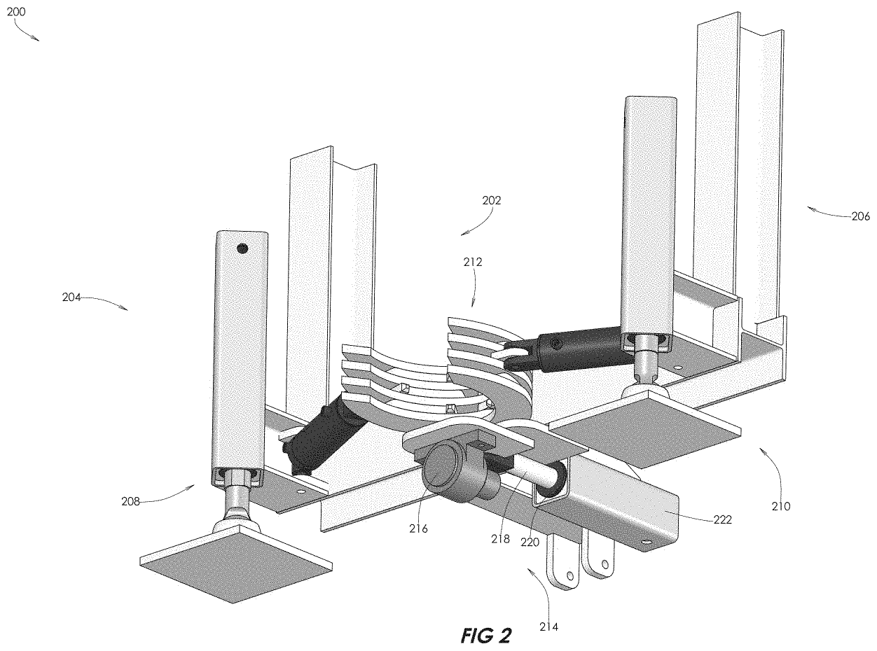

FIGS. 1A-1F illustrate perspective views of a pulling apparatus 100 in accordance with the principles of the present disclosure. In one embodiment, the apparatus 100 can include a frame 102. In another embodiment, the frame 102 can include a first side 104 and a second side 106. For example, the frame 102 can include one or more beams 152, 154, 156, 158, 160 that can provide a basic structure to the apparatus 100. In another example, the frame 102 can include first and second vertical members 152, 154 at the first and second sides 104, 106 of the frame 102, respectively. In another example, the frame 102 can include a crossbeam 156, such as crossbeam 156 that can be coupled with the first and second vertical members 152, 154. In another example, the frame 102 can include first and second horizontal member 158, 160 on the first and second sides 104, 106 of the frame 102, respectively. For example, the horizontal members 158, 160 can be coupled with the crossbeam 156 and protrude therefrom. In another embodiment, the frame 102 can include a third vertical member 148 and a fourth vertical member 150 on the first side 104 and second side 106 of the frame 102, respectively. In one example, the third and fourth vertical members 148, 150 can be tubes.

In one embodiment, the frame 102 can be configured to couple to a vehicle. For example, one or more beams and/or vertical members (such as beams 152, 154, 156, 158, 160 and/or vertical members 148, 150, 152, 154) and/or supports (such as supports 108, 110) can be configured to couple to a vehicle. In one example, the frame 102 can include holes, such as bolt holes, wire holes, or any other holes to facilitate the coupling of the frame 102 to a vehicle. In another embodiment, the frame 102 can include clamps, magnets, rivets, ledges, indentions, welding, or any other mechanism and/or component suitable to couple the frame 102 and/or apparatus 100 with a vehicle. In another example, the frame 102 can include clamps configured to grasp a vehicle, such as edges of a loader bucket of a vehicle. In another example, the frame 102 can include one or more lips and/or ledges, such as to facilitate resting of the frame 102 on a lip and/or ledge of a vehicle, such as a loader bucket of a vehicle. In another example, the frame 102 can facilitate the gripping of a vehicle clamp and/or other component on the frame 102, such as via beams and/or vertical member. In another embodiment, the frame 102 can be configured to attach to a trailer hitch, such as a ball hitch, three-point-hitch, etc. In another example, the frame 102 can include wheels, such as to allow the frame to roll. In another example, the apparatus 100 can be integrated with a vehicle. For example, the apparatus 100 can be mounted with an engine and/or wheels and/or any other suitable vehicle components, such as to enable the apparatus 100 to be mobile without attachment to a vehicle.

In another example, the third and fourth vertical members 148, 150 can be configured to couple to first and second support members (extrudable support members) 108, 110, respectively. For example, the tubes 148, 150 can be configured to receive first and second support members 108, 110, respectively. For example, the first and second tubes 148, 150 can be configured to receive first and second cylinders 130, 132 of the first and second support member 108, 110, respectively. In one embodiment, cylinders 130, 132 can be hydraulic cylinders For example, the tubes 148, 150 can include bolt holes configured to align with bolt holes of cylinders 130, 132, such that the cylinders 130, 132 can be coupled to the tubes 148, 150. In another example, the third and fourth vertical member 148, 150 can be of any suitable design or structure to couple to support members 108, 110 and/or the frame 102 and/or lend structure to the frame 102 and/or provide support to the apparatus 100. In another embodiment, the frame 102 can include rods, mesh, struts, beams, supports, tubes, or any other constituents suitable to provide structure to the apparatus 100. For example, one or more of the beams 152, 154, 156, 158, 160 and/or members discussed herein can be rods, such as to minimize the profile and/or weight of the apparatus 100. In another example, of the beams 152, 154, 156, 158, 160 discussed herein can be angle irons. In another embodiment, the frame 102 can be made of steel, iron, polymer, plastic, or any other suitable material.

In another embodiment, the apparatus 100 can include a first support member 108 and a second support member 110. For example, the first and second support members 108, 110 can be configured to support the apparatus 100 and/or the frame 102. In another example, the support members 108, 110 can be coupled to the frame 102. In another embodiment, the support members 108, 110 can include shafts 112, 114. For example, the shafts 112, 114 can be configured to extrude from the frame 102. In another example, the shafts 112, 114 can be configured to extrude from the frame, such as to drive the frame in a direction opposite the direction of extrusion. For example, the support members 108, 110 can include shafts 112, 114 operably coupled with cylinders 130, 132, which, in one embodiment, can be hydraulically powered, such that the shafts 112, 114 can be extruded from the cylinders 130, 132 upon engagement of a hydraulic system associated with the cylinders 130, 132 and/or shafts 112, 114. In this manner, and in one embodiment, the support members 108, 110 can be hydraulically powered. In another embodiment, the support members 108, 110 can be electrically powered, such that extrusion of the shafts 112, 114 can be accomplished via electrical energy.

In another embodiment, the support members 108, 110 can include first ends 134, 136. For example, the first ends 134, 136 can be configured to mobilize away from the frame 102 as the shafts 112, 114 mobilize during extrusion. In another embodiment, the first ends 134, 136 can be configured to couple with feet, such as feet 116, 118. In one example, the first ends 134, 136 can include ball studs, such as ball studs that can be configured to participate in a ball joint and/or other pivotal coupling. For example, the feet 116, 118 can include cups 138, 140 configured to receive ball studs 134, 136, such that points of coupling between the shafts 112, 114 and the feet 116, 118 can be operable to rotate. In one example, such pivotal coupling can be advantageous in that it can allow the first and second support members 108, 110 to extrude the shafts 112, 114 against a surface (e.g., the ground), and the feet 116, 118 can rotate around the ball studs 134, 146 via the cups 138, 140, such that the feet 116, 118 can adapt to irregularities (e.g. sloped, uneven, non-flat, etc.) in the surface and maximize the surface area against which the support members 108, 110 can extrude against, such as to drive the frame 102 away from the surface. In another embodiment, the feet 116, 118 can be coupled to the shafts 112, 114 by welding, bolts, or any other mechanism suitable to couple the feet 116, 118 to the shafts 112, 114 and allow the feet 116, 118 to support the frame 102 and/or apparatus 100.

In another embodiment, the apparatus 100 can include a gripping member 120. For example, the gripping member 120 can include jaws, such as interlocking jaws. In another embodiment, the gripping member 120 can include texturing, corrugation, spikes, or any other elements operable to facilitate gripping of an object by the gripping member 120. In another example, the gripping member 120 can include spikes configured to impale an object. In another example, the gripping member 120 can include fingers, hands, clamps, or any other elements suitable to facilitate the gripping of an object (e.g., a tree, pole, stanchion, rock, animal, etc.) by the apparatus 100. In another embodiment, the gripping member 120 can hydraulically powered. For example, the gripping member 120 can include hydraulic cylinders 122 configured to facilitate gripping by the gripping member 120. For example, the gripping member 120 can include jaws, and hydraulic cylinders 122 can facilitate opening and closing of the jaws. In another example, the hydraulic cylinders 122 can mobilize spikes of a gripping member 120, such that spikes can impale an object, such that the object can be gripped by the spikes.

In another embodiment, the gripping member 120 can be configured to receive an object of a particular shape. For example, the gripping member 120 can be rounded and/or include rounded jaws, such that rounded and/or cylindrical objects (e.g., trees) can be accommodated. In one embodiment, the gripping member 120 can be configured to maximize a surface area of contact between the gripping member 120 and an object gripped therein. For example, the gripping member 120 can include jaws and/or rounded jaws, such that the gripping member 120 can maximize a surface area that the gripping member 120 grips of the object. In another example, the gripping member 120 can be configured to grip a tree, such as by including rounded jaw members that can accommodate a tree shape. In another embodiment, the griping member 120 can include jaws configured to interlock, such that an object can be gripped as tightly as possible by the gripping member 120. For example, the gripping member 120 can include jaw members each having prongs, e.g. semi-circular prongs, spaced apart by a particular distance, such that each of the prongs of the jaw members can intermesh upon closing of the jaws. For example, as the griping member 120 grips an object, the gripping member 120 can close as far as it needs to grip objects of different diameters. In another embodiment, the gripping member 120 can include at least two jaw members, each of which can be mobile, e.g., operated by a hydraulic cylinder such as hydraulic cylinders 122.

In another embodiment, the apparatus 100 can include an impactor member 124. For example, the impactor member 124 can be disposed below the gripping member 120, such as between the first and second sides 104, 106 of the frame 102. In one example, the impactor member 124 can include one or more tines 142. In one embodiment, the tines 142 can be configured to impact, shake, impale, scrape, or affect any other motion or contact on an object, such as an object that can be gripped by the gripping member 120. In another example, the impactor member 124 can be hydraulically powered. In one embodiment, the impactor member 124 can be coupled with one or more cylinders 126, 128 that can facilitate movement of the impactor member 124 in one or more planes of movement. For example, cylinders 126 can facilitate movement of the impactor member 124 in a vertical plane. In another example, cylinders 128 can facilitate movement of the impactor member 124 in a lateral plane. In another embodiment, the impactor member 124 can be electrically powered, manually powered, or operated via any mechanism suitable to mobilize the impactor member 124. In one example, cylinders 124 and/or 126 can be hydraulic cylinders, and/or hydraulic cylinders with pistons configured to extrude and drive the impactor member 124. In another embodiment, the impactor member 124 can be configured to move in any direction. In another embodiment, the impactor member 124 can be saw or saws, such as to apply a cutting impact to an object. In another embodiment, the impactor member 124 can be of any suitable design to facilitate the segmentation and/or scraping and/or separation and/or clearing and/or cleaning of at least a portion of an object held by gripping member 120.

In another embodiment, the impactor member 124 can include one or more stabilizers 144, such as stabilizers 144 coupled to the impactor member 124. For example, stabilizers 144 can be rods, poles, bolts, or any other elements suitable to stabilize the impactor member 124, such as when the impactor member 124 is mobilized. In another example, the stabilizers 144 can be configured to engage one or more tracks 146, such as tracks 146 coupled to the frame 102. For example, the stabilizers 144 can include rods with one or more ends that can engage the tracks 146. In one embodiment, the ends can be wheels, caps, or any other configuration suitable to allow the stabilizers 144 to engage the tracks 146. In another example, the tracks 146 can be coupled to the frame 102, such as under the gripping member 120, such that the impactor member 124 can travel laterally as facilitated by the tracks 146 and stabilizers 144. For example, the impactor member 124 can mobilize towards an object held by the gripping member 120, and such movement can be stabilized by the stabilizers 144 within the tracks 146. In another embodiment, the impactor member 124 can be stabilized by any other suitable mechanism, including additional hydraulic cylinders, bolts, ties, chains, tubes, or any other mechanism suitable to support and/or stabilize the impactor member 124 during operation. In another embodiment, the impactor member 124 can be configured to operate without stabilizers 144 or tracks 146.

In another embodiment, the gripping member 120 can include at least one axis, such as axis “A”. For example, the gripping member 120 can include a central area and/or middle portion, such as, in one embodiment, an area between jaws of the gripping member 120. In another example, an axis can be central axis, e.g. an axis that divides the central area. In another embodiment, the central axis can be any axis traversing a plane that the gripping member 120 resides in. In another embodiment, an axis of the gripping member 120 can be any axis that traverses, touches, and/or is tangential to the gripping member 120. In another embodiment, the first and second support members 108, 110 can be positioned along an axis of the gripping member 120. For example, as seen in FIG. 1D, an axis “A” can traverse the gripping member 120, and the first and second support members 108, 110 can be positioned along such axis. In one embodiment, such positioning of the support members 108, 110 can facilitate the aligning of force vectors, such as when shafts 112, 114 of the support member 108, 110 extrude and drive the frame 102 in the direction opposite the direction of extrusion. In another embodiment, such positioning of the support members 108, 110 along a gripping member 120 axis (e.g., axis “A”) can optimize driving of an object held by the gripping member 120. For example, an object held by the gripping member 120 can be forced upwards via extrusion of the shafts 112, 114 of the support members 108, 110, and positioning of the support members 108, 110 along a gripping member 120 axis can optimize a driving force provided by extrusion, such as by counterbalancing the forces applied by each support member 108, 110.

In one embodiment, the apparatus 100 can facilitate the raising of an object from a surface, e.g., the pulling of a tree from the ground. For example, the apparatus 100 can be oriented with respect to an object, the object can be gripped by the gripping member 120, the support members 108, 110 and/or feet 116, 118 can be buttressed against the ground, and the support members 108, 110 can extrude their respective shafts 112, 114 to hoist the object upwards. In another embodiment, the apparatus 100 can include one or more cameras, sensors, haptic feedback modules, controllers, processor, or any other components suitable to facilitate and/or enable the gripping of objects by the apparatus 100, hoisting of objects by the apparatus 100, or other operation or movement of the apparatus 100. For example, a camera can be mounted to the frame 102, e.g. to provide video feed to an operator of a vehicle that the apparatus 100 is coupled to, such that navigation of the apparatus 100 can be enhanced. In another example, a controller can be in operable communication with, e.g., the gripping member 120, impactor member 124, and/or support members 108, 110, such that one or more operations of the apparatus 100 can be automated and/or controlled via, e.g., electrical signalling. In another embodiment, a sensor can be coupled with the apparatus 100, such that, e.g., the sensor can determine when/if an object is properly oriented with respect to the gripping member 120. In another example, any number of cameras, sensors, controllers, or other components can be coupled with and/or in operable communication with the apparatus 100 and/or vehicle the apparatus 100 is coupled to and/or the operator of the vehicle to facilitate operation and/or movement of the apparatus 100. In another embodiment, the apparatus 100 can be in operable communication with controls of a vehicle. In another embodiment, the apparatus 100 can be in operable communication with a control panel, such as a control panel that can be mounted with in a vehicle cabin.

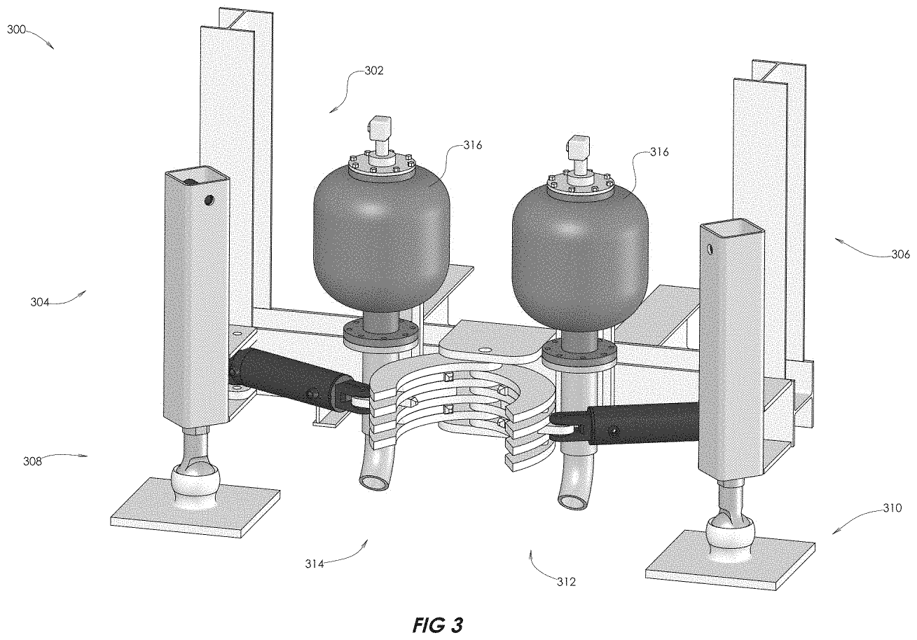

FIG. 2 depicts another embodiment of the present disclosure. In one embodiment, a tree pulling apparatus 200 can be similar to the pulling apparatus 100—for example, the apparatus 200 can include a frame 202 with first and second sides 204, 206, first and second support members 208, 210, a gripping member 212, and an impactor member 214. In another embodiment, the apparatus 200 can include a frame 202 having a first side 204 and a second side 206, a first support member 208 and a second support member 210, a gripping member 212, and an impactor member 214. In another embodiment, the impactor member 214 can include a face 216, a shaft 218, a hydraulic cylinder, and a housing (tube) 222. For example, the impactor member 214 can be configured to extrude the face 216 outwards from the frame 202, such as via the shaft 218 and cylinder 220. In another embodiment, the housing 222 can be considered part of the frame 202. In another embodiment, the impactor member 214 can be configured to vibrate. For example, the impactor member 214 can be configured to extrude the face 216 towards and/or into an object and vibrate, such as to facilitate dislodging and/or disunion of an object and/or collection of objects. In another embodiment, the impactor member 214 can be configured to extrude the face 216 with a force suitable to cause an impact, such as an impact with an object held by the gripping member 212. For example, the impactor member 214 can be configured to utilize the face 216 like a hammer to impact and/or segment of an object and/or collection of objects. In another example, the impactor member 214 can be configured to impact a root system and/or a root ball of a pulled tree. In another example, the impactor member 214 can facilitate the removal of dirt, rock, etc. from roots of a tree, such as by hammering at the tree and/or vibrating the roots.

FIG. 3 illustrates another embodiment of the present disclosure. In one embodiment, a tree clearing apparatus 300 can be similar to the pulling apparatus 100—for example, the apparatus 300 can include a frame 302 with first and second sides 304, 306, first and second support members 308, 310, a gripping member 312, and an impactor member 314. In one embodiment, the impactor member 314 can include a pneumatic cannon system. In another embodiment, the impactor member 314 can include a nozzle configured to extend from the frame 302, such as to extend toward and/or into an object held by the gripping member 312. In another embodiment, the apparatus 300 can include one or more reservoirs 316 coupled to the frame 302. For example, the one or more reservoirs 316 can be charged with compressed air. In another example, the one or more reservoirs 316 can be charged with any other gas, fluid, liquid, or other material. In another example, the one or more reservoirs 316 can be operably coupled with the nozzle of the impactor member 314, such that the nozzle can dispense material from the one or more reservoirs 316. In another example, the impactor member 314 can be configured to impact a root system and/or a root ball of a pulled tree. In another example, the impactor member 314 can facilitate the removal of dirt, rock, etc. from roots of a tree, such as by expelling pressurized fluid into the root system and/or root ball.

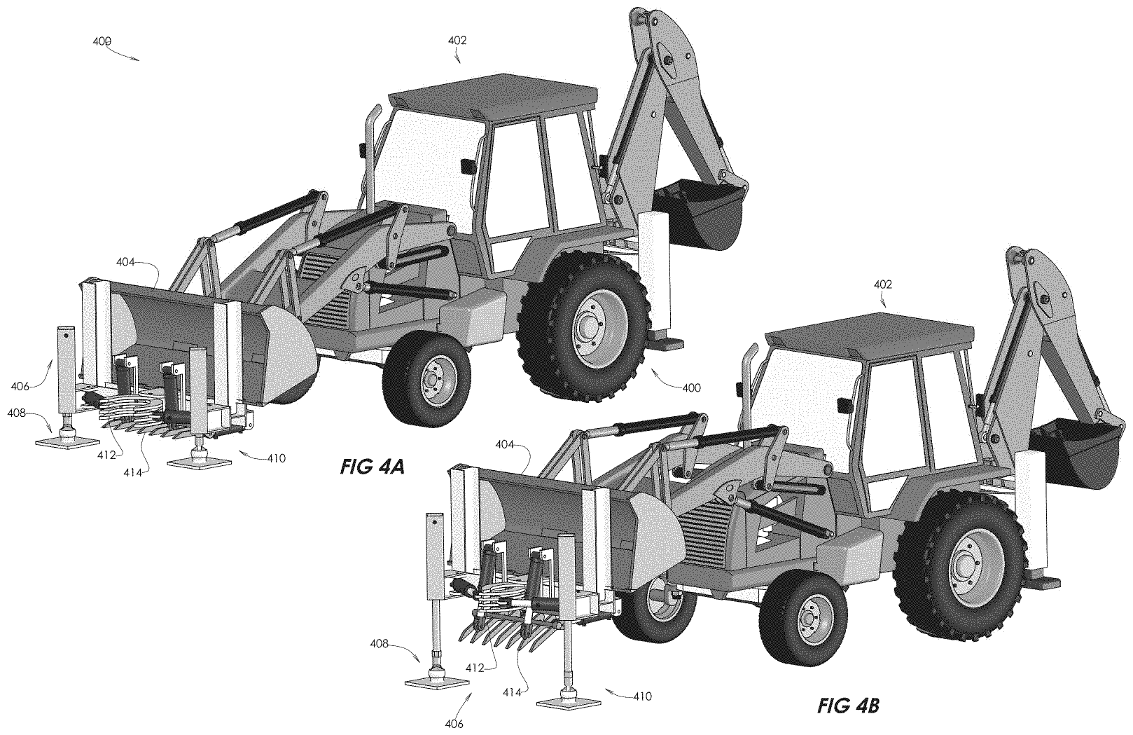

FIGS. 4A-4B illustrate another embodiment of the present disclosure. A tree-pulling system 400 can include a vehicle 402 having a loader bucket (loading bucket) 404 and a pulling apparatus 406. Pulling apparatus 406 can be similar to and/or be pulling apparatus 100, tree pulling apparatus 200, and/or tree clearing apparatus 300. For example, the pulling apparatus 406 can include a first support member 408, a second support member 410, a gripping member 412, and/or an impactor member 414. In one embodiment, the pulling apparatus 406 can be coupled to the vehicle 402, such as to the loading bucket 404 of the vehicle. The apparatus 406 can be coupled to the vehicle 402 via bolts, ties, chains, screws, magnetism, welding, or any other mechanism suitable to couple the apparatus 406 to the vehicle 402 and/or loader bucket 404.

In another embodiment, the apparatus 406 can be coupled with a power source and/or system, such as a hydraulic system, electrical system, battery, or any other power source and/or system, of the vehicle 402. For example, the apparatus 406 can be hydraulically operated (e.g., the support members 408, 410 can be configured to extrude and/or drive the frame via hydraulics, the gripping member 412 can be configured to open and close hydraulically, and/or the impactor member 414 can be configured to operate hydraulically), and the apparatus 406 can be coupled with and/or integrated into a hydraulic system of the vehicle 402, such that, e.g., the apparatus 406 can be powered by the vehicle 402 and/or the hydraulic system and/or fluid of the vehicle 402. In another embodiment, the apparatus 406 can be electrically powered, and the apparatus 406 can be coupled with an electrical system of the vehicle 402, such that the vehicle 402 can provide power to the apparatus 406. In another embodiment, the apparatus 406 can be configured to utilize one or more power sources, such as hydraulics and electricity, and further be coupled with one or more systems of the vehicle 402, such that the vehicle 402 can provide power to the apparatus 406. In another embodiment, the apparatus 406 can be self-powered, e.g. the apparatus 406 can be configured to operate and/or be powered with being coupled with a vehicle 402 system.

In another embodiment, FIG. 4A can illustrate the system 400 in a lowered position, e.g., such as the system 400 could be in prior to having pulled and/or raised an object from a surface (and/or pulling a tree from the ground). For example, the gripping member 412 can be poised to grip an object—in one embodiment, the gripping member 412 can be jaws that can be opened, such as to receive an object therein. For example, an object can be oriented relative the gripping member 412, e.g. positioned between the jaws of the gripping member 412, positioned to be impaled by the gripping member 412, etc., such as to facilitate gripping of an object by the gripping member 412. In another embodiment, the support member 408, 410 can be in a non-extruded position. For example, the support members 408, 410 can be support members in accordance the principles of one or more embodiments of the present disclosure, and shafts of the support members 408, 410 can be significantly recessed towards and/or into the frame of the apparatus 406. In another embodiment, the impactor member 414 of the of the apparatus 406 can be withdrawn towards a frame of the apparatus 406, such that the gripping member 412 can have a clear path to grip an object. In one embodiment, the loader bucket 404 of the vehicle 402 can be in a lowered position, such as to allow the apparatus 406 to rest on the ground and/or directly above the ground.

In one embodiment, FIG. 4B can illustrate the system 400 in a raised position, such as it could be in after and/or during raising an object from a surface (and/or pulling a tree from the ground). For example, the gripping member 412 can be in a closed position and/or be gripping an object, such as a tree, pole, shaft, rock, or any other object. In another example, the support members 408, 410 can be in an extruded position (e.g. shafts of the support member 408, 410 can be extruded from the frame of the apparatus 406). In another embodiment, extrusion of the support members 408, 410 and/or of the shafts of the support members 408, 410 can facilitate the raising of the apparatus 406. In one example, raising of the apparatus 406 can be accomplished via the support members 408, 410 without assistance from raising of the loading bucket 404. In another embodiment, raising of the apparatus 406 can be accomplished via any combination of the support members 408, 410 and/or the loader bucket 404 and/or vehicle 402. In another embodiment, the impactor member 414 can be extended outwards, downwards, and/or in any other direction, such as to impact an object held by the gripping member 412.

In another embodiment, the apparatus 406 can be coupled with the vehicle 402, such as with a loader bucket 404 of a vehicle, such that the apparatus 406 can raise (e.g., via the support members 408, 410) without raising the bucket 404 and/or vehicle 402. For example, a frame of the apparatus 406 can be coupled to the bucket 404 via clamps attached to tracks, such that as the apparatus 406 raises (such as via extrusion of the support member 408, 410), the apparatus 406 can remain attached to the bucket 404 while not exerting a lifting force on the bucket 404. In another embodiment, the apparatus 406 can be configured such that raising via the support members 408, 410 can raise the gripping member 412 and/or impactor member 414 without raising a frame of the apparatus 406. In another embodiment, the apparatus 406 can raise via the support member 408, 410 and the bucket 404 can raise with the apparatus 406. For example, the apparatus 406 can lift the bucket 404, and/or the bucket 404 can be raised via vehicle 402 power (e.g. the hydraulic system of the vehicle with which the bucket 404 can be coupled).

In one embodiment, the apparatuses, systems, and methods disclosed herein can facilitate the raising of an object from a surface and/or the driving and/or pulling of an object away from a surface. For example, an object can be oriented relative to a gripping member of a pulling apparatus in accordance with the principles of the present disclosure. In another example, the apparatus can grip the object via the gripping member. In another example, support members of the apparatus can apply a force against the surface to which the object is attached and/or on which the object rests. In another example, application of force by the support members on the surface, along with the gripping of the object by the gripping member of the apparatus, can create a separating force between the object and the surface. In another example, an impactor member of the apparatus can be engaged, such as to pulverize, clean, scrape, separate, or otherwise impact an object held by the gripping member. For example, the impactor member can be used to segment a root system of a pulled tree. For example, the impactor member can include one or more tines that can impact and/or impale the root ball, and movement of the impactor member (such as via, e.g., hydraulic cylinders) can facilitate the disunion of the root system, and/or mud, dirt, rock, or other debris and/or objects attached to the root system. In another example, the object can then be maintained in a secured state by the gripping member, and the support members can be recessed, such that the apparatus and grasped object can be, e.g., held above the ground, such as by a loader bucket of a vehicle, and/or moved to another location via a vehicle to which the apparatus is coupled, such as to the deposit the object at a different location.

The present disclosure achieves at least the following advantages:

1. Optimizing pulling capability via at least two extrudable support members;

2. Enhancing tree pulling and clearing via an impactor member configured to apply one or more forces to an object gripped by a pulling apparatus;

3. Optimizing tree pulling capability by aligning force vectors of support members with gripping member and/or object gripped by gripping member;

4. Providing a method of pulling and clearing tree species with entangled and/or complex root systems;

5. Enhancing tree pulling via support members and attached feet capable of pivoting to account for geographical and/or topographical irregularities;

6. Enabling a new use for standard vehicles; and

7. Providing a mobile tree pulling apparatus configured to couple with known vehicles and/or equipment.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f).

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A pulling apparatus, the apparatus comprising:
a frame including a first side and a second side;
a first support member operably coupled to the first side of the frame, the first support member including a first shaft having a first end;
a second support member operably coupled to the second side of the frame, the second support member including a second shaft having a first end; and
a gripping member coupled to the frame between the first and second support members,
wherein each of the first and second shafts are configured to extrude from the frame.

2. The apparatus of claim 1, wherein the frame is configured to couple to a vehicle.

3. The apparatus of claim 1, wherein each of the first and second support members are configured to drive the frame via extrusion of the first and second shafts.

4. The apparatus of claim 1, wherein extrusion of the first and second shafts is hydraulically powered.

5. The apparatus of claim 1, further comprising an impactor member disposed below the gripping member.

6. The apparatus of claim 5, wherein the impactor member includes at least one tine.

7. The apparatus of claim 1, wherein the gripping member is hydraulically powered.

8. The apparatus of claim 5, wherein the impactor member is hydraulically powered.

9. The apparatus of claim 1, further comprising a first foot coupled to the first end of the first shaft and a second foot coupled to the first end of the second shaft.

10. The apparatus of claim 9, wherein the first ends of the first and second shafts include ball studs.

11. The apparatus of claim 10, wherein each of the first foot and second foot include a cup.

12. The apparatus of claim 1, wherein each of the first and second support members are positioned along an axis of the gripping member.

13. The apparatus of claim 1, wherein the gripping member includes jaws.

14. The apparatus of claim 1, wherein the frame is configured to couple to a loader bucket.

15. A method of raising an object from a surface, the method comprising the steps of:
orienting an object relative to a gripping member coupled to a frame, wherein the gripping member is coupled between a first side and a second side of the frame;
gripping the object with the gripping member; and
driving the object and the frame upwards via a first extrudable support coupled proximate the first side of the frame and a second extrudable support coupled proximate the second side of the frame.

16. The method of claim 15, wherein the frame is coupled to a vehicle.

17. The method of claim 16, wherein at least one of the first extrudable support, second extrudable support, and gripping member is powered via the vehicle.

18. A tree-pulling system, the system comprising:
a vehicle including a loader bucket;
a pulling apparatus including:
a frame including a first side and a second side;
a first support member operably coupled to the first side of the frame, the first support member including a first shaft;
a second support member operably coupled to the second side of the frame, the second support member including a second shaft; and
a gripping member coupled to the frame between the first and second support members,
wherein the frame is coupled to the loader bucket.

19. The system of claim 18, wherein each of the first and second shafts are configured to extrude from the frame.

20. The system of claim 18, wherein the pulling apparatus is configured to couple with hydraulics of the vehicle.
